(19) United States
(12) Patent Application Publication
(10) Pub. No.: US 2025/0014594 A1
(43) Pub. Date: Jan. 9, 2025

(54) Dual Free Layer TMR Reader With Shaped Rear Bias and Methods of Forming Thereof

(71) Applicant: Western Digital Technologies, Inc., San Jose, CA (US)

(72) Inventors: Ming MAO, Dublin, CA (US); Yung-Hung WANG, San Jose, CA (US); Chih-Ching HU, Pleasanton, CA (US); Chen-Jung CHIEN, Mountain View, CA (US); Carlos CORONA, Pleasanton, CA (US); Hongping YUAN, Fremont, CA (US); Ming JIANG, San Jose, CA (US); Goncalo Marcos BAIÃO DE ALBUQUERQUE, San Jose, CA (US)

(73) Assignee: Western Digital Technologies, Inc., San Jose, CA (US)

(21) Appl. No.: 18/890,207

(22) Filed: Sep. 19, 2024

Related U.S. Application Data
(62) Division of application No. 17/899,823, filed on Aug. 31, 2022.

(51) Int. Cl. G11B 5/11; G11B 5/265

(52) U.S. Cl. CPC G11B 5/11; G11B 5/2658

(57) ABSTRACT

The present disclosure generally relates to a dual free layer (DFL) read head and methods of forming thereof. In one embodiment, a method of forming a DFL read head comprises depositing a DFL sensor, defining a stripe height of the DFL sensor, depositing a rear bias (RB) adjacent to the DFL sensor, defining a track width of the DFL sensor and the RB, and depositing synthetic antiferromagnetic (SAF) soft bias (SB) side shields adjacent to the DFL sensor. In another embodiment, a method of forming a DFL read head comprises depositing a DFL sensor, defining a track width of the DFL sensor, depositing SAF SB side shields adjacent to the DFL sensor, defining a stripe height of the DFL sensor and the SAF SB side shield, depositing a RB adjacent to the DFL sensor and the SAF SB side shield, and defining a track width of the RB.

### CROSS-REFERENCE TO RELATED APPLICATIONS

This application is a divisional of co-pending U.S. patent application Ser. No. 17/899,823, filed Aug. 31, 2022, which is herein incorporated by reference.

### BACKGROUND OF THE DISCLOSURE

### Field of the Disclosure

Embodiments of the present disclosure generally relate to a dual free layer (DFL) read head and methods of forming thereof.

### Description of the Related Art

Read heads, which are configured to read data from a media, generally comprise two free layers to be dual free layer (DFL) readers or sensors. In DFL reader operation, the two free layers are individually stabilized longitudinally by an anti-ferromagnetically coupled (AFC) soft bias (SB) and biased transversally by a permanent magnet or a rear hard bias (RHB) structure from the stripe back edge of the sensor. Recently, the track width of the dual free layer read heads have been decreasing. However, the smaller track width of the DFL read heads can limit performance of the DFL read heads, as the signal-to-noise ratio may degrade.

Moreover, a transverse bias field of DFL read heads is determined by the remnant magnetization (Mr) times thickness (t) product (i.e., Mr*t) of the RHB structure. Since a saturation magnetization, Ms, and thus, the Mr of the RHB is quite limited (e.g., as compared to the Ms of the soft bias), a thicker RHB is generally required to achieve the desired transverse bias field. However, the thicker RHBs may certainly result in a larger undesirable topography along the stripe direction, and in turn limit DFL readers for TDMR applications. In addition, a large RHB comprising a granular material may result in an unintended read-out signal polarity flip due to the RHB biasing direction flip, further negatively impacting the overall performance and reliability of the DFL read heads. Furthermore, the granular nature of a large sized RHB certainly determines the transversal bias field with intrinsic non-uniformity and the limitation to read heads with smaller track widths for higher areal recording density due to significant performance degradations.

Therefore, there is a need in the art for an improved DFL read head.

### SUMMARY OF THE DISCLOSURE

The present disclosure generally relates to a dual free layer (DFL) read head with a shaped rear bias (RB) and methods of forming thereof. A rear bias, in general, can be a rear hard bias (RHB) or a rear soft bias (RSB). In one embodiment, a method of forming a DFL read head comprises depositing a DFL sensor, defining a stripe height of the DFL sensor, depositing a rear bias (RB) adjacent to the DFL sensor, defining a track width of the DFL sensor and the RB, and depositing synthetic antiferromagnetic (SAF) soft bias (SB) side shields adjacent to the DFL sensor. In another embodiment, a method of forming a DFL read head comprises depositing a DFL sensor, defining a track width of the DFL sensor, depositing SAF SB side shields adjacent to the DFL sensor, defining a stripe height of the DFL sensor, depositing a RB adjacent to the DFL sensor, and defining a track width of the RB.

In one embodiment, a method of forming a DFL read head comprises forming a DFL sensor, defining a stripe height of the DFL sensor, the DFL sensor being disposed at a media facing surface, forming a RB adjacent to the DFL sensor, the RB being recessed from the media facing surface, defining a track width of the DFL sensor and the RB, and forming SAF SB side shields adjacent to the DFL sensor and the RB.

In another embodiment, a method of forming a DFL read head comprises forming a DFL sensor, defining a track width of the DFL sensor, the DFL sensor being disposed at a media facing surface, forming SAF SB side shields adjacent to the DFL sensor, defining a stripe height of the DFL sensor and the SAF SB side shields, the stripe height of the DFL sensor and the SAF SB side shields being substantially equal, forming a RB adjacent to the DFL sensor and the SAF SB side shields, the RB being recessed from the media facing surface, and defining a track width of the RB.

In yet another embodiment, DFL read head comprises a DFL sensor disposed at a media facing surface (MFS), the DFL sensor having a first track width, synthetic antiferromagnetic (SAF) soft bias (SB) side shields adjacent to the DFL sensor at the MFS, wherein the DFL sensor and the SAF SB side shields collectively have a second track width at the MFS, and a read bias disposed adjacent to the DFL sensor recessed from the MFS, the rear bias having a third track width less than the second track width.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a disk drive embodying this disclosure.

FIG. 2 is a fragmented, cross-sectional side view through the center of a read/write head facing a magnetic media, according to one embodiment.

FIGS. 3A-3B illustrate a dual free layer (DFL) read head, according to one embodiment.

FIGS. 4A-4C illustrate a perspective view of a method of forming a DFL read head with as a plan view in FIG. 4D.

FIGS. 5A-5E illustrate a perspective view of a method of forming a DFL read head with a shaped RB, according to another embodiment with a plan view shown in FIG. 5F.

FIGS. 6A-6F illustrate perspective view of a method of forming a DFL read head with a shaped RB, according to another embodiment with a plan view shown in FIG. 6G.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to a dual free layer (DFL) read head with a shaped rear bias (RB) and methods of forming thereof. In one embodiment, a method of forming a DFL read head comprises depositing a DFL sensor, defining a stripe height of the DFL sensor, depositing a rear bias (RB) adjacent to the DFL sensor, defining a track width of the DFL sensor and the RB, and depositing synthetic antiferromagnetic (SAF) soft bias (SB) side shields adjacent to the DFL sensor. In another embodiment, a method of forming a DFL read head comprises depositing a DFL sensor, defining a track width of the DFL sensor, depositing SAF SB side shields adjacent to the DFL sensor, defining a stripe height of the DFL sensor and the SAF SB side shields, depositing a RB adjacent to the DFL sensor and the SAF SB side shields, and defining a track width of the RB.

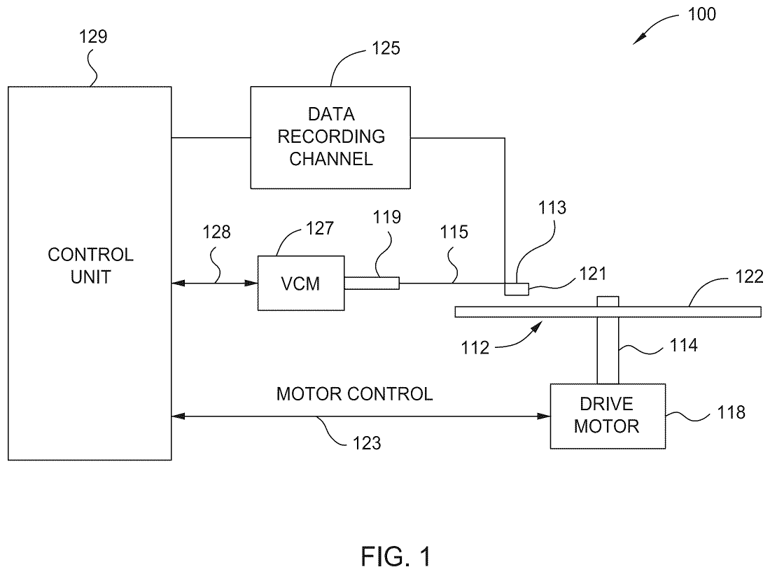

FIG. 1 is a schematic illustration of a magnetic recording device 100, according to one implementation. The magnetic recording device 100 includes a magnetic recording head, such as a write head. The magnetic recording device 100 is a magnetic media drive, such as a hard disk drive (HDD). Such magnetic media drives may be a single drive/device or include multiple drives/devices. For the ease of illustration, a single disk drive is shown as the magnetic recording device 100 in the implementation illustrated in FIG. 1. The magnet recording device 100 (e.g., a disk drive) includes at least one rotatable magnetic disk 112 supported on a spindle 114 and rotated by a drive motor 118. The magnetic recording on each rotatable magnetic disk 112 is in the form of any suitable patterns of data tracks, such as annular patterns of concentric data tracks on the rotatable magnetic disk 112.

At least one slider 113 is positioned near the rotatable magnetic disk 112. Each slider 113 supports a head assembly 121. The head assembly 121 includes one or more magnetic recording heads (such as read/write heads), such as a write head including a spintronic device. As the rotatable magnetic disk 112 rotates, the slider 113 moves radially in and out over the disk surface 122 so that the head assembly 121 may access different tracks of the rotatable magnetic disk 112 where desired data are written. Each slider 113 is attached to an actuator arm 119 by way of a suspension 115. The suspension 115 provides a slight spring force which biases the slider 113 toward the disk surface 122. Each actuator arm 119 is attached to an actuator 127. The actuator 127 as shown in FIG. 1 may be a voice coil motor (VCM). The VCM includes a coil movable within a fixed magnetic field, the direction and speed of the coil movements being controlled by the motor current signals supplied by a control unit 129.

The head assembly 121, such as a write head of the head assembly 121, includes a media facing surface (MFS) such as an air bearing surface (ABS) that faces the disk surface 122. During operation of the magnetic recording device 100, the rotation of the rotatable magnetic disk 112 generates an air or gas bearing between the slider 113 and the disk surface 122 which exerts an upward force or lift on the slider 113. The air or gas bearing thus counter-balances the slight spring force of suspension 115 and supports the slider 113 off and slightly above the disk surface 122 by a small, substantially constant spacing during operation.

The various components of the magnetic recording device 100 are controlled in operation by control signals generated by control unit 129, such as access control signals and internal clock signals. The control unit 129 includes logic control circuits, storage means and a microprocessor. The control unit 129 generates control signals to control various system operations such as drive motor control signals on a line 123 and head position and seek control signals on a line 128. The control signals on line 128 provide the desired current profiles to optimally move and position slider 113 to the desired data track on rotatable magnetic disk 112. Write and read signals are communicated to and from the head assembly 121 by way of recording channel 125. In one embodiment, which can be combined with other embodiments, the magnetic recording device 100 may further include a plurality of media, or disks, a plurality of actuators, and/or a plurality number of sliders.

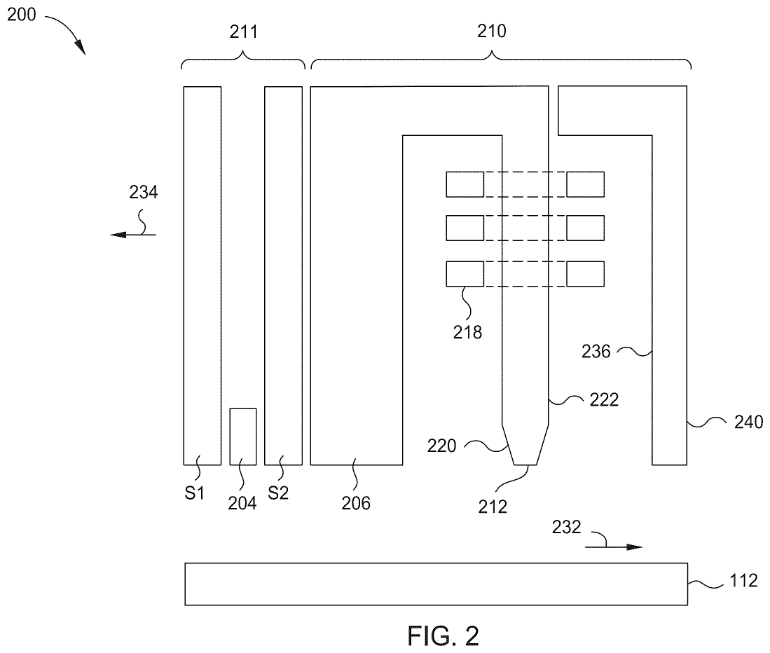

FIG. 2 is a fragmented, cross sectional side view through the center of a read/write head 200 facing the magnetic media 112, according to one embodiment. The read/write head 200 may correspond to the magnetic head assembly 121 described in FIG. 1. The read/write head 200 includes a media facing surface (MFS) 212, such as an air bearing surface (ABS), a magnetic write head 210, and a magnetic read head 211, and is mounted such that the MFS 212 is facing the magnetic media 112. The read/write head 200 may be an energy-assisted magnetic recording (EAMR) head or a perpendicular magnetic recording (PMR) head. In FIG. 2, the magnetic media 112 moves past the write head 210 in the direction indicated by the arrow 232 and the read/write head 200 moves in the direction indicated by the arrow 234.

In some embodiments, the magnetic read head 211 is a SOT-based reader 204 located between the shields S1 and S2. In other embodiments, the magnetic read head 211 is a magnetoresistive (MR) read head that includes an MR sensing element 204 located between MR shields S1 and S2. In some other embodiments, the magnetic read head 211 is a magnetic tunnel junction (MTJ) read head that includes a MTJ sensing element 204 located between MR shields S1 and S2. The magnetic fields of the adjacent magnetized regions in the magnetic media 112 are detectable by the MR (or MTJ) sensing element 204 as the recorded bits.

The write head 210 includes a return pole 206, a main pole 220, a trailing shield 240, and a coil 218 that excites the main pole 220. The coil 218 may have a “pancake” structure which winds around a back-contact between the main pole 220 and the return pole 206, instead of a “helical” structure shown in FIG. 2. A trailing gap (not shown) and a leading gap (not shown) may be in contact with the main pole and a leading shield (not shown) may be in contact with the leading gap. A recording magnetic field is generated from the main pole 220 and the trailing shield 240 helps making the magnetic field gradient of the main pole 220 steep. The main pole 220 may be a magnetic material such as a FeCo alloy. The main pole 220 may include a trailing surface 222 which may be parallel to a leading surface 236 of the trailing shield 240. The main pole 220 may be a tapered write pole (TWP) with a trailing edge taper (TET) configuration. In one embodiment, the main pole 220 has a saturated magnetization (Ms) of 2.4 T and a thickness of about 300 nanometers (nm). The main pole 220 may comprise ferromagnetic materials, typically alloys of one or more of Co, Fe, and Ni. The trailing shield 240 may be a magnetic material such as NiFe alloy. In one embodiment, the trailing shield 240 has an Ms of about 1.2 T to about 1.6 T.

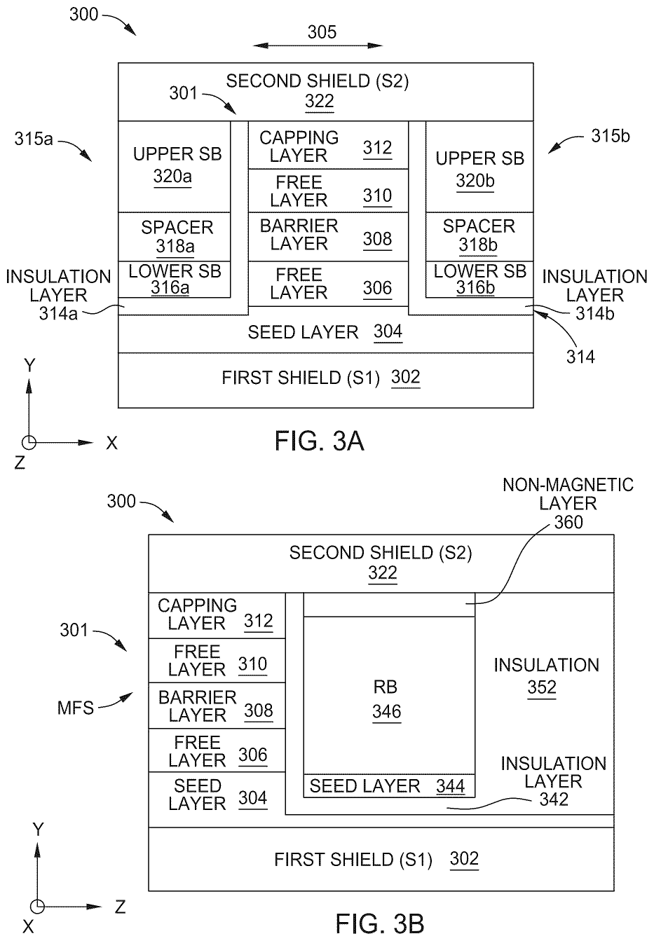

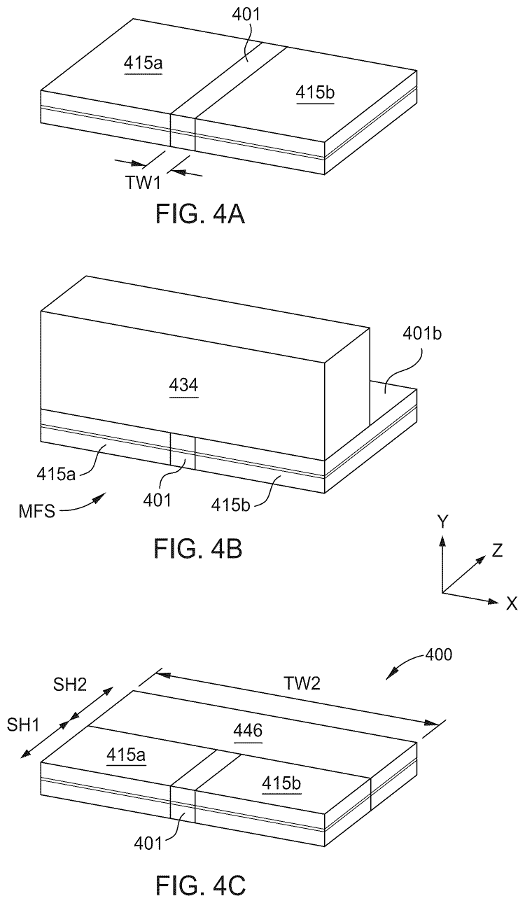

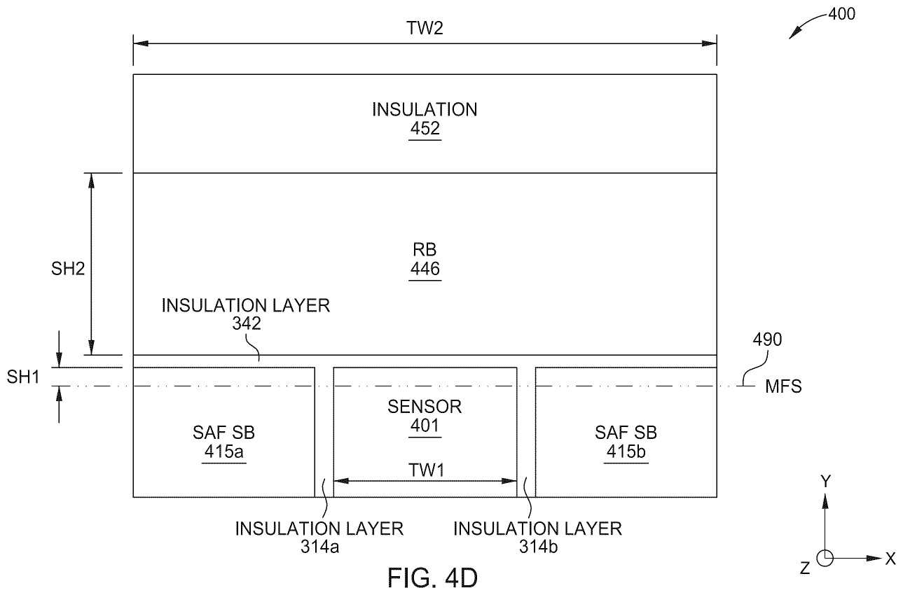

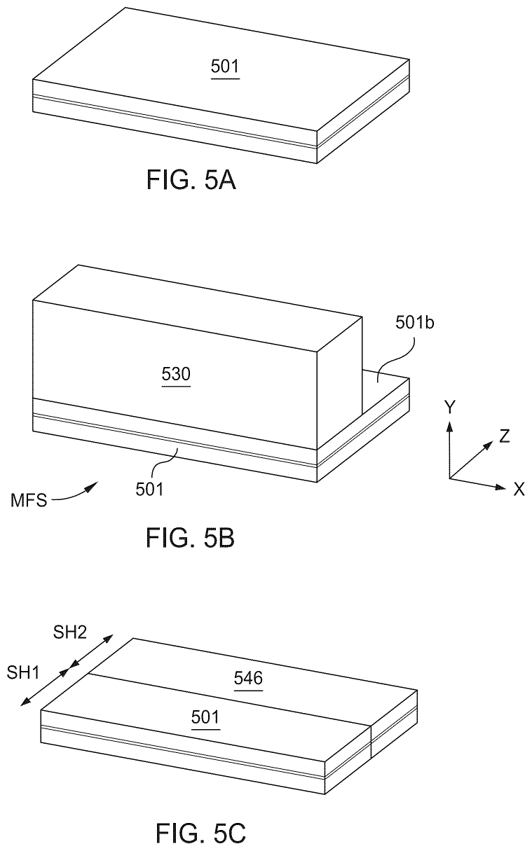

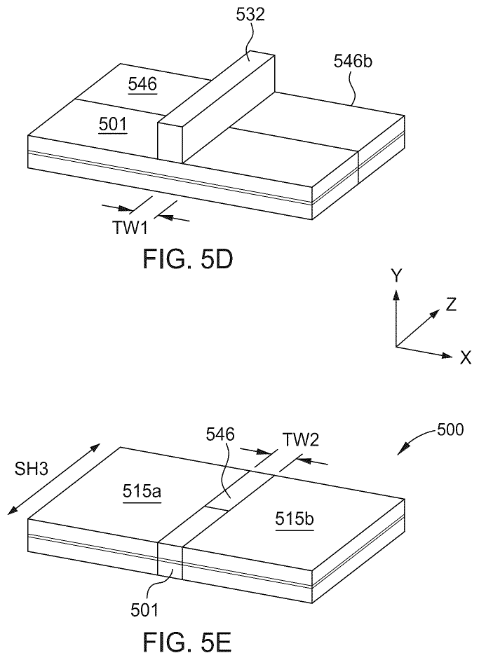

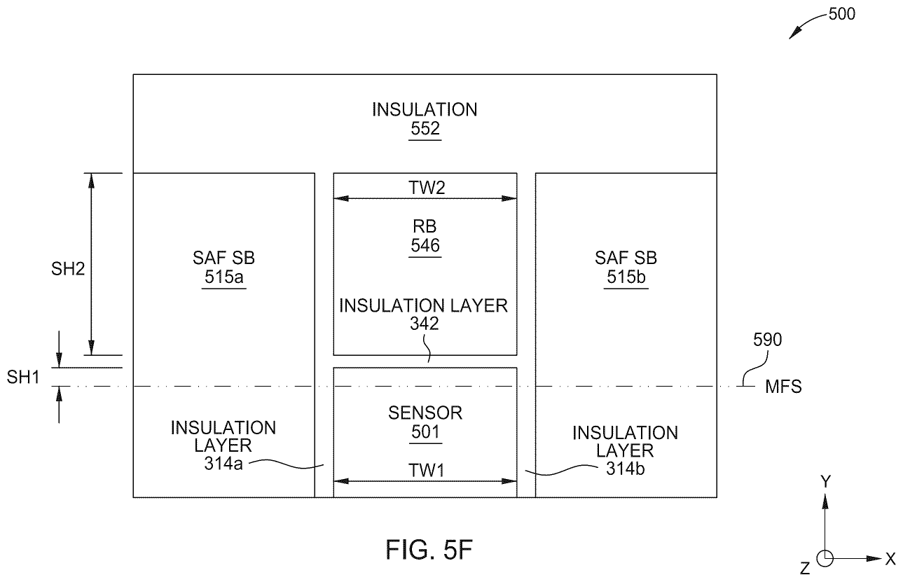

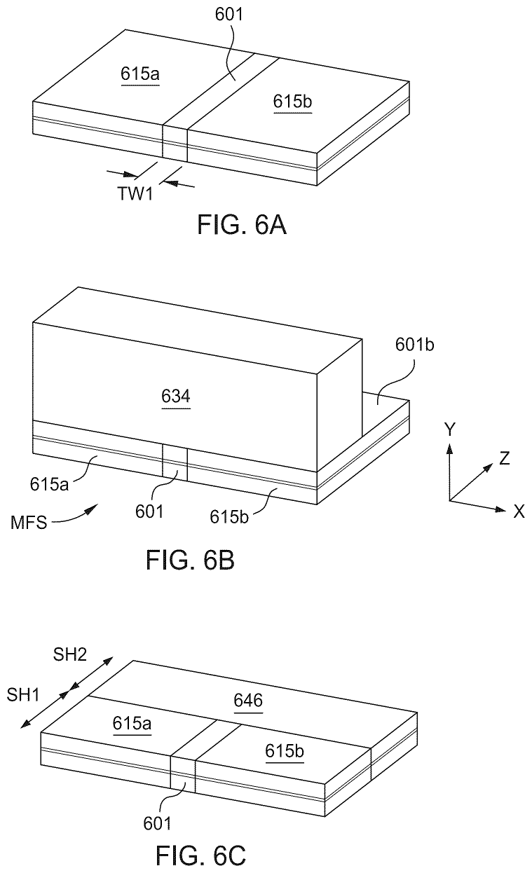

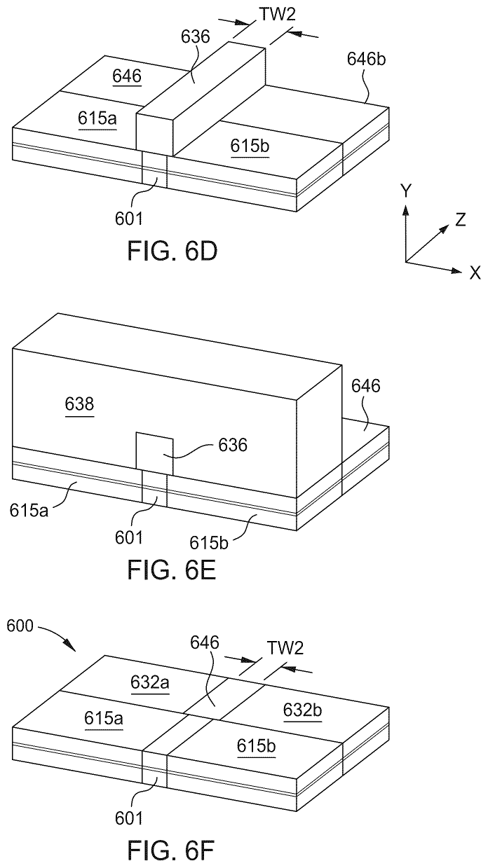

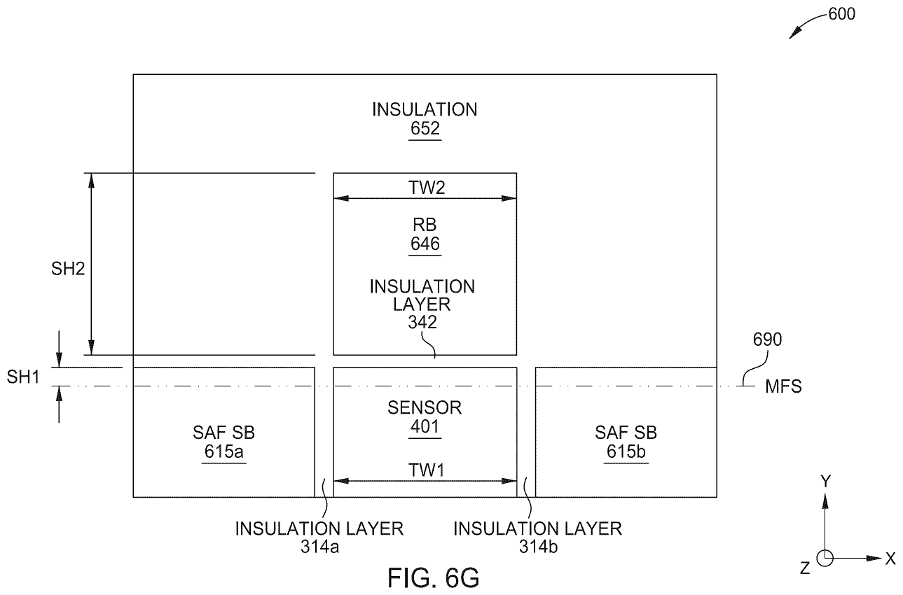

FIGS. 3A-3B illustrate a dual free layer (DFL) read head 300, according to one embodiment. FIG. 3A illustrates a media facing surface (MFS) view of the DFL read head 300, and FIG. 3B illustrates an APEX (i.e., a vertical cross-sectional) view of the DFL read head 300. The DFL read head 300 may correspond to, or be a part of, the magnetic head assembly 121 described in FIG. 1. The DFL read head 300 may correspond to, or be a part of, the read/write head 200 described in FIG. 2, such as the magnetic read head 211. The DFL read head 300 may be formed as described below in FIGS. 4A-4C, and/or in FIGS. 5A-5E, and/or in FIG. 6A-6F.

The DFL read head 300 includes a first shield (S1) 302, a seed layer 304, a first free layer (FL) 306, a barrier layer 308, a second FL 310, a capping layer 312, and a second shield (S2) 322. The seed layer 304, the first FL 306, the barrier layer 308, the second FL 310 and the capping layer 312 form a DFL read sensor 301 of the DFL read head 300. The DFL read sensor 301 has a track width 305 in the x-direction of about 10 nm to about 30 nm±about 2 nm. The seed layer 304 includes a material selected from the group that includes tantalum (Ta), ruthenium (Ru), titanium (Ti), cobalt hafnium (CoHf), and combinations thereof. In one embodiment, the barrier layer 308 comprises MgO. The first FL 306 and the second FL 310 may each individually comprise cobalt iron (CoFe), cobalt boron (CoB), cobalt iron boron (CoFeB), cobalt hafnium (CoHf), cobalt iron hafnium (CoFeHf) and combinations thereof. The capping layer 312 may comprise Ta, Ru, Ti, CoHf and combinations thereof.

The DFL read head 300 further includes a first synthetic antiferromagnetic (SAF) soft bias (SB) side shield 315a that includes a first lower SB layer 316a, a first spacer 318a such as ruthenium, and a first upper SB layer 320a and a second SAF SB side shield 315b that includes a second lower SB layer 316b, a second spacer 318b such as ruthenium, and a second upper SB layer 320b. The SAF SB layers 316a, 316b, 320a, 320b may comprise NiFe and/or CoFe and combinations thereof. The magnetic moments or magnetization directions for the first FL 306 and the second FL 310 may be antiparallel due to the antiparallel biasing from the SAF SB side shields 315a, 315b (collectively referred to as SAF SB side shields 315). The DFL read sensor 301 is insulated from SAF SB side shields 315 by insulation layers 314a, 314b (collectively referred to as insulation layers 314). The insulation layers 314 may be aluminum oxide (AlOx), magnesium oxide (MgO) or any other suitable insulation material, and combinations thereof.

As shown in FIG. 3B, the DFL read head 300 further includes a rear bias (RB) 346 and a second insulation layer 342. The RB 346 is isolated electrically by a second insulation layer 342 from the DFL read sensor 301 and the first shield 302. The second insulation layer 342 may be aluminum oxide (AlOx), magnesium oxide (MgO), any other suitable insulation material, and combinations thereof. A bottom portion of the RB 346 disposed adjacent to the first shield 302 is spaced from the second insulation layer 342 by a seed layer 344, where the seed layer 344 has a same width in the z-direction as the RB 346. The RB 346 is further insulated by the first insulation layer 352 on the other side away from the DFL read sensor 301 (e.g., recessed from the MFS). The first insulation layer 352 may be aluminum oxide (AlOx) or any other suitable insulation material. The RB 346 generates a magnetic field pointing away from the insulation layer 352 and towards the following layers: the first FL 306, the barrier layer 308, the second FL 310, and the capping layer 312. The RB 346 is magnetically decoupled from the second shield 322 by inserting a nonmagnetic layer 360 between RB 346 and the second shield 322. The RB 346 may comprise CoPt, and in such cases, referred to as rear hard bias (RHB). The RB 346 may also comprise NiFe and/or CoFe and combinations thereof, and in such cases, referred to as rear soft bias (RSB). Generally, both the material of the RHB 346 and the material of the RSB 346 or the SAF SB side shields 315 are polycrystalline. As such, the granular nature of the material of the RB 346 determines the degree of the intrinsic non-uniformity of the transverse bias fields depending on its magneto-crystalline anisotropy.

The RB 346 has a magnetization direction (e.g., in the z-direction) perpendicular to a magnetization direction (e.g., in the x-direction) of the first FL 306 and the second FL 310. Before the magnetic recording head comprising the DFL read head 300 is shipped from the production line, the RB 346 typically needs to be magnetically initialized by a magnetic field in the z-direction.

FIGS. 4A-4C illustrate a perspective view of a method of forming a conventional DFL read head 400. FIG. 4D illustrates a top plan view of the DFL read head 400 after the RB formation described in FIG. 4C, according to one embodiment. The DFL read head 400 may be the DFL read head 300 of FIGS. 3A-3B. As such, the DFL sensor 401 may be the DFL sensor 301, the RB 446 may be the RB 346, and the SAF SB side shields 415a, 415b may be the SAF SB side shields 315a, 315b. The DFL read head 400 may correspond to, or be a part of, the read/write head 200 described in FIG. 2, such as the magnetic read head 211.

In FIG. 4A, the DFL sensor 401 is deposited, and the track width (TW1) of the DFL sensor 401 is defined in the x-direction. The DFL sensor 401 may be a multilayer structure, as described above, comprising a first shield, a seed layer disposed on the first shield, a first free layer disposed on the seed layer, a barrier layer disposed on the first free layer, a second free layer disposed on the barrier layer, a capping layer disposed on the second free layer, and a second shield disposed on the capping layer. The DFL sensor 401 has a track width in the x-direction of about 10 nm to about 30 nm±about 2 nm. Upon defining the track width of the DFL sensor 401, the SAF SB side shields 415a, 415b are formed on the sides of the DFL sensor 401 in the x-direction. Each of the SAF SB side shields 415a, 415b (collectively referred to herein as SAF SB side shields 415) have a greater track width than the DFL sensor 401. The SAF SB side shields 415 may be multilayer structures, as described above, comprising NiFe, CoFe, combinations thereof, and Ru.

In FIG. 4B, a first photoresist 434 is deposited on a front portion or front half of the DFL sensor 401 and the SAF SB side shields 415, such as from the MFS to about halfway towards the surface 401b opposite the MFS. The first photoresist 434 extends across the width of the DFL sensor 401 in the x-direction.

In FIG. 4C, the exposed or uncovered portions of DFL sensor 401 and the SAF SB side shields 415 are milled or removed to define a stripe height (SH1) of both the DFL sensor 401 and the SAF SB side shields 415 in the z-direction. After a thin insulation layer 342 (shown in FIG. 4D) has been deposited, the RB 446 is formed adjacent to the DFL sensor 401 and the SAF SB side shields 415, recessed from the MFS, where the uncovered portion of the DFL sensor 401 and the SAF SB side shields 415 previously were. The RB 446 may comprise CoPt as a RHB. The first photoresist 434 is then removed. The stripe height (SH1) of the DFL sensor 401 and the SAF SB side shields 415 and the stripe height (SH2) of the RB 446 each individually has a height of about 15 nm to about 40 nm, and about 200 nm to about 1000 nm for a lapped read head after the formation of the MFS (shown by the dashed line 490 in FIG. 4D). The track width (TW1) of the DFL sensor 401 and the track width (TW2) of the RB 446 each individually has a width of about 15 nm to about 40 nm, and about 1000 nm to about 2000 nm for a lapped read head after the formation of the MFS (shown by the dashed line 490 in FIG. 4D).

In thus formed DFL read heads 400, the large RB 446 area demands RHB to be used to sustain read-out operation due to its large intrinsic magneto-crystalline anisotropy. A large RHB comprising a granular material may result in an unintended read-out signal polarity flip due to the RHB biasing direction flip, hence negatively impact the reliability of the DFL read heads 400. The granular nature of a large sized RHB certainly determines the transversal bias field with intrinsic non-uniformity and limits DFL read heads 400 with smaller track widths for higher areal recording density due to significant performance degradations.

FIGS. 5A-5E illustrate a perspective view of a method of forming a DFL read head 500 with a shaped RB 546, according to one embodiment. FIG. 5F illustrates a top plan view of the DFL read head 500 after the RB formation described in FIG. 5E, according to one embodiment. The DFL read head 500 may be the DFL read head 300 of FIGS. 3A-3B. As such, the DFL sensor 501 may be the DFL sensor 301, the RB 546 may be the RB 346, and the SAF SB side shields 515a, 515b may be the SAF SB side shields 315a, 315b. The DFL read head 500 may correspond to, or be a part of, the read/write head 200 described in FIG. 2, such as the magnetic read head 211.

As shown in FIG. 5A, the DFL sensor 501 is deposited. The DFL sensor 501 may be a multilayer structure, as described above, comprising a first shield, a seed layer disposed on the first shield, a first free layer disposed on the seed layer, a barrier layer disposed on the first free layer, a second free layer disposed on the barrier layer, a capping layer disposed on the second free layer, and a second shield disposed on the capping layer. In FIG. 5B, a first photoresist 530 is deposited on a portion of the DFL sensor 501. The first photoresist 530 is deposited on a front portion or front half of the DFL sensor 501, such as from the MFS to about halfway towards the surface 501b opposite the MFS. The first photoresist 530 extends across the width of the DFL sensor 501 in the x-direction.

In FIG. 5C, the back portion or the exposed portion of the DFL sensor 501 is milled or removed to define a stripe height (SH1) in the z-direction of the DFL sensor 501, leaving only the portion of the DFL sensor 501 covered by the first photoresist 530. After a thin insulation layer 342 (shown in FIG. 5F) has been deposited, the RB 546 is formed across the insulation layer 342 adjacent to the DFL sensor 501 over the first shield 302 (not shown), recessed from the MFS, where the uncovered portion of the DFL sensor 501 previously was. The RB 546 may comprise CoPt as a RHB or NiFe, CoFe, and combinations thereof as a RSB. The first photoresist 530 is then removed. In some embodiments, the SH1 of the DFL sensor 501 and the SH2 of the RB 546 in the z-direction each individually has a height of about 15 nm to about 40 nm, and about 200 nm to about 1000 nm in a lapped DFL read head 500 after the formation of the MFS (shown by the dashed line 590 in FIG. 5F).

In FIG. 5D, a hard mask stencil 532 defined by a second photoresist is formed on the DFL sensor 501 and the RB 546 to define a track width (TW) in the x-direction of both the DFL sensor 501 and the RB 546. The hard mask stencil 532 extends from the MFS to a surface 546b of the RB 546 opposite the MFS. The hard mask stencil 532 may have a width in the x-direction of about 15 nm to about 30 nm±about 2 nm.

FIG. 5E shows the results of three processes after FIG. 5D. First, the exposed portions or side portions of both the DFL sensor 501 and the RB 546 are milled or removed, leaving only the portions of the DFL sensor 501 and the RB 546 covered by the hard mask stencil 532. Removing the exposed portions of the RB 446 shapes the read bias of the RB 546. Upon removing the exposed portions, the DFL sensor 501 and the RB 546 have a defined track width in the x-direction. The track width (TW1) of the DFL sensor 501 and the track width (TW2) of the RB 546 are substantially the same with a width of about 15 nm to about 30 nm±about 2 nm. Second, the SAF SB side shields 515a, 515b are then formed adjacent to the DFL sensor 501 and the RB 546 in the x-direction and the −x-direction. The SAF SB side shields 515a, 515b may be multilayer structures, as described above, comprising NiFe, and/or CoFe, and Ru. The SAF SB side shields 515a, 515b have a stripe height (SH3) in the z-direction equal to the stripe heights SH1 and SH2 of the DFL sensor 501 and the RB 546 collectively. Each of the SAF SB side shields 515a, 515b has a track width of about 500 nm to about 1000 nm, which is greater than both the DFL sensor 501 and the RB 546. Third, the hard mask stencil 532 is then removed. FIG. 5E shows the state after this third process.

Forming the DFL read head 500 as described in FIGS. 5A-5F allows the DFL sensor 501 and the RB 546 to be self-aligned, as the track width of the DFL sensor 501 and the RB 546 is defined at the same time. Furthermore, the RB 546 is shaped to match the DFL sensor 501, which induces shape anisotropy. The shaped RB 546 further increases the transverse magnetic anisotropy to align bias element magnetization along the z-direction and allow a consistent and effective transverse bias field to be delivered to the DFL read head 500. The increased transverse magnetic anisotropy thus improves bias point control and reliability of the DFL read head 500, enabling smaller track width (e.g., less than about 20 nm) DFL read heads 500 with ensured performance.

FIGS. 6A-6F illustrate a perspective view of a method of forming a DFL read head 600, according to another embodiment. FIG. 6G illustrates a top plan view of the DFL read head 500 after the RB formation described in FIG. 6F, according to one embodiment. The DFL read head 600 may be the DFL Read head 300 of FIGS. 3A-3B. As such, the DFL sensor 601 may be the DFL sensor 301, the RB 646 may be the RB 346, and the SAF SB side shields 615a, 615b may be the SAF SB side shields 315a, 315b. The DFL read head 600 may correspond to, or be a part of, the read/write head 200 described in FIG. 2, such as the magnetic read head 211.

In FIG. 6A, the DFL sensor 601 is deposited, and the track width of the DFL sensor 601 is defined in the x-direction. The DFL sensor 601 may be a multilayer structure, as described above, comprising a first shield, a seed layer disposed on the first shield, a first free layer disposed on the seed layer, a barrier layer disposed on the first free layer, a second free layer disposed on the barrier layer, a capping layer disposed on the second free layer, and a second shield disposed on the capping layer. The DFL sensor 601 has a track width in the x-direction of about 10 nm to about 30 nm±about 2 nm. Upon defining the track width of the DFL sensor 601, the SAF SB side shields 615a, 615b are formed on the sides of the DFL sensor 601 in the x-direction. Each of the SAF SB side shields 615a, 615b (collectively referred to herein as SAF SB side shields 615) has a greater track width than the DFL sensor 601. The SAF SB side shields 615 may be multilayer structures, as described above, comprising NiFe, and/or CoFe, and Ru.

In FIG. 6B, a first photoresist 634 is deposited on a front portion or front half of the DFL sensor 601 and the SAF SB side shields 615, such as from the MFS to about halfway towards the surface 601b opposite the MFS. The first photoresist 634 extends across the width of the DFL read head 600 in the x-direction.

In FIG. 6C, the exposed or uncovered portions of DFL sensor 601 and the SAF SB side shields 615 are milled or removed to define a stripe height (SH1) of both the DFL sensor 601 and the SAF SB side shields 615 in the z-direction. After a thin insulation layer 342 (shown in FIG. 6G) has been deposited, the RB 646 is then formed across the insulation layer 342 adjacent to the DFL sensor 601 and the SAF SB side shields 615 over the first shield 302, recessed from the MFS, where the uncovered portion of the DFL sensor 601 and the SAF SB side shields 615 previously were. The insulation layer 342 can be a thin layer with a thickness sufficient for insulation before a metal layer comprising non-magnetic or magnetic materials is deposited with a thickness complemental to the single insulation layer thickness. The RB 646 may comprise CoPt as a RHB, or NiFe, CoFe, and combinations thereof as a RSB. The first photoresist 634 is then removed. In some embodiments, the SH1 of the DFL sensor 601 and the SAF SB side shields 615 and the stripe height (SH2) of the RB 646 in the z-direction each individually has a height of about 15 nm to about 40 nm, and about 500 nm to about 1000 nm in a lapped DFL read head after the formation of the MFS (shown by the dashed line 690 in FIG. 6G).

In FIG. 6D, a hard mask stencil 636 defined by a second photoresist is formed over the DFL sensor 601 and a portion of the RB 646 to define a track width (TW2) of the RB 646. The hard mask stencil 636 extends from the MFS to a surface 646b opposite the MFS. The hard mask stencil 636 has a width in the x-direction greater than or equal to the track width TW1 of the DFL sensor 601. The TW2 is aligned with TW1 with a tolerable offset in x-direction of about +0 nm to about 3 nm.

In FIG. 6E, a second photoresist 638 is deposited over the hard mask stencil 636 and the SAF SB side shields 615. The second photoresist 638 extends across the width of the SAF SB side shields 615 in the x-direction and in the z-direction. The second photoresist 638 has a height in the z-direction equal to the stripe height SH1 of the DFL sensor 601 with a tolerable offset in z-direction of about +0 nm to about 3 nm.

In FIG. 6F, the exposed or uncovered portions of the RB 646 are milled or removed to shape the read bias of the RB 646. Insulation layers 632a, 632b are then deposited adjacent to the RB 646 and behind the SAF SB side shields 615, recessed from the MFS. The second photoresist 638 is removed, followed by removing the hard mask stencil 636. Because the TW1 of the DFL sensor 601 and the TW2 of the RB 646 are individually defined, the TW2 of the RB 646 may be equal to or greater than the TW1 of the DFL sensor 601, and a formation process different from that for the DFL sensor 601 can be used to preserve the physical properties of RB materials at defined track widths. In some embodiments, the TW2 of the RB 646 is two to three times greater than the TW1 of the DFL sensor 601. Thus, the TW2 of the RB 646 may be between about 20 nm to about 60 nm.

Forming the DFL read head 600 as described in FIGS. 6A-6F results in the DFL sensor 601 having a track width of less than about 15 nm. Furthermore, the RB 646 track width is formed independently from the DFL sensor 601 track width, ensuring bias material properties and performance of the RB 646 are not lost or reduced at a smaller track width of the DFL sensor while inducing shape anisotropy. The shaped RB 646 further increases the transverse magnetic anisotropy to align bias element magnetization, which allows a consistent transverse bias field to be effectively delivered to the DFL read head 600. The SAF SB side shields 615 remain shaped with the induced shape anisotropy while ensuring performance stability of the DFL read head 600. The increase in the transverse biasing field comes from two aspects in terms of (1) shape induced better bias element magnetization alignment and (2) bias element magnetization itself when NiFe, CoFe, and combinations thereof, are used as higher moment materials as in the case of RSB. These improve bias point control and reliability of the DFL read head 600, enabling smaller track width (e.g., less than about 15 nm) DFL read heads 600 with ensured performance.

Therefore, by forming a DFL read head as described herein, the track width of the DFL sensor is reduced to about 10 nm without limiting performance or the signal-to-noise ratio of the DFL read head. The RB is precisely shaped, which increases the transverse magnetic anisotropy to align bias element magnetization and allows a consistent and sufficient transverse bias field to be effectively delivered to the DFL read head. As such, DFL read heads formed as described herein achieve smaller DFL sensor track widths with ensured performance and reliability.

In one embodiment, a method of forming a DFL read head comprises forming a DFL sensor, defining a stripe height of the DFL sensor, the DFL sensor being disposed at a media facing surface, forming a RB adjacent to the DFL sensor, the RB being recessed from the media facing surface, defining a track width of the DFL sensor and the RB, and forming SAF SB side shields adjacent to the DFL sensor and the RB.

The track widths of the DFL sensor and the RB are substantially equal. The stripe height of the DFL sensor is shorter than a stripe height of the RB. A stripe height of the SAF SB side shields is greater than the stripe height of the DFL sensor. A track width of the SAF SB side shields is greater than the track width of the DFL sensor. The track width of the DFL sensor is about 15 nm to about 30 nm. The SAF SB side shields comprise one or more of NiFe, CoFe, and Ru. The RB comprises CoPt as a RHB, or NiFe, CoFe, and combinations thereof as a RSB. Defining the track width of the DFL sensor and the RB further comprises: forming a hard mask stencil over a portion of the DFL sensor and the RB, the hard mask stencil having a width equal to or greater than the track width of the DFL sensor and RB, removing exposed portions of the DFL sensor and RB uncovered by the hard mask stencil, and removing the hard mask stencil. A magnetic recording device comprising a DFL read head formed by the method.

In another embodiment, a method of forming a DFL read head comprises forming a DFL sensor, defining a track width of the DFL sensor, the DFL sensor being disposed at a media facing surface, forming SAF SB side shields adjacent to the DFL sensor, defining a stripe height of the DFL sensor and the SAF SB side shields, the stripe height of the DFL sensor and the SAF SB side shields being substantially equal, forming a RB adjacent to the DFL sensor and the SAF SB side shields, the RB being recessed from the media facing surface, and defining a track width of the RB.

The track width of the RB is equal to or greater than the track width of the DFL sensor. The track width of the DFL sensor is about 10 nm to about 30 nm, and wherein the track width of the RB is about 20 nm to about 60 nm. A track width of the SAF SB side shields is greater than the track width of the RB. A stripe height of the RB is greater than the stripe height of the DFL sensor and the SAF SB side shields. The method further comprises depositing insulating layers adjacent to the RB and the SAF SB side shields, the insulating layers being recessed from the media facing surface. The SAF SB side shields comprise one or more of NiFe, CoFe and Ru, and wherein the RB comprises CoPt as a RHB, or NiFe, CoFe, and combinations thereof as a RSB. The SAF SB side shields are multilayer structures. The DFL sensor comprises a first shield, a seed layer disposed on the first shield, a first free layer disposed on the seed layer, a barrier layer disposed on the first free layer, a second free layer disposed on the barrier layer, a capping layer disposed on the second free layer, and a second shield disposed on the capping layer. A magnetic recording device comprising a DFL read head formed by the method.

In yet another embodiment, DFL read head comprises a DFL sensor disposed at a media facing surface (MFS), the DFL sensor having a first track width, synthetic antiferromagnetic (SAF) soft bias (SB) side shields adjacent to the DFL sensor at the MFS, wherein the DFL sensor and the SAF SB side shields collectively have a second track width at the MFS, and a read bias disposed adjacent to the DFL sensor recessed from the MFS, the rear bias having a third track width less than the second track width.

The first track width and the third track width are substantially equal. The third track width is two to three times greater than the first track width. The first track width and the third track width are individually defined during a fabrication process of the DFL read head. The SAF SB side shields have a first stripe height greater than a second stripe height of the DFL sensor. The SAF SB side shields have a third stripe height substantially equal to a fourth stripe height of the DFL sensor. A magnetic recording device comprises the DFL read head.

While the foregoing is directed to embodiments of the present disclosure, other and further embodiments of the disclosure may be devised without departing from the basic scope thereof, and the scope thereof is determined by the claims that follow.

What is claimed is:

1. A method of forming a dual free layer (DFL) read head, comprising:
forming a DFL sensor;
defining a stripe height of the DFL sensor, the DFL sensor being disposed at a media facing surface;
forming a rear bias (RB) adjacent to the DFL sensor, the RB being recessed from the media facing surface;
defining a track width of the DFL sensor and the RB; and
forming synthetic antiferromagnetic (SAF) soft bias (SB) side shields adjacent to the DFL sensor and the RB.

2. The method of forming the DFL read head of claim 1, wherein the track widths of the DFL sensor and the RB are substantially equal.

3. The method of forming the DFL read head of claim 1, wherein the stripe height of the DFL sensor is shorter than a stripe height of the RB.

4. The method of forming the DFL read head of claim 1, wherein a stripe height of the SAF SB side shields is greater than the stripe height of the DFL sensor.

5. The method of forming the DFL read head of claim 1, wherein a track width of the SAF SB side shields is greater than the track width of the DFL sensor.

6. The method of forming the DFL read head of claim 1, wherein the track width of the DFL sensor is about 15 nm to about 30 nm.

7. The method of forming the DFL read head of claim 1, wherein the SAF SB side shields comprise one or more of NiFe, CoFe, and Ru.

8. The method of forming the DFL read head of claim 1, wherein the RB comprises CoPt as a rear hard bias, or NiFe, CoFe, and combinations thereof as a rear soft bias.

9. The method of forming the DFL read head of claim 1, wherein defining the track width of the DFL sensor and the RB further comprises:
forming a hard mask stencil over a portion of the DFL sensor and the RB, the hard mask stencil having a width equal to or greater than the track width of the DFL sensor and RB;
removing exposed portions of the DFL sensor and RB uncovered by the hard mask stencil; and
removing the hard mask stencil.

10. A magnetic recording device comprising a DFL read head formed by the method of claim 1.

11. A method of forming a dual free layer (DFL) read head, comprising:
forming a DFL sensor;
defining a track width of the DFL sensor, the DFL sensor being disposed at a media facing surface;
forming synthetic antiferromagnetic (SAF) soft bias (SB) side shields adjacent to the DFL sensor;
defining a stripe height of the DFL sensor and the SAF SB side shields, the stripe height of the DFL sensor and the SAF SB side shields being substantially equal;
forming a rear bias (RB) adjacent to the DFL sensor and the SAF SB side shields, the RB being recessed from the media facing surface; and
defining a track width of the RB.

12. The method of forming the DFL read head of claim 11, wherein the track width of the RB is equal to or greater than the track width of the DFL sensor.

13. The method of forming the DFL read head of claim 12, wherein the track width of the DFL sensor is about 10 nm to about 30 nm, and wherein the track width of the RB is about 20 nm to about 60 nm.

14. The method of forming the DFL read head of claim 11, wherein a track width of the SAF SB side shields is greater than the track width of the RB.

15. The method of forming the DFL read head of claim 11, wherein a stripe height of the RB is greater than the stripe height of the DFL sensor and the SAF SB side shields.

16. The method of forming the DFL read head of claim 11, further comprising depositing an insulating layer adjacent to the RB and the SAF SB side shields, the insulating layers being recessed from the media facing surface.

17. The method of forming the DFL read head of claim 11, wherein the SAF SB side shields comprise one or more of NiFe, CoFe and Ru, and wherein the RB comprises CoPt as a rear hard bias, or NiFe, CoFe, or combinations thereof as a rear soft bias.

18. The method of forming the DFL read head of claim 11, wherein the SAF SB side shields are multilayer structures.

19. The method of forming the DFL read head of claim 11, wherein the DFL sensor comprises a first shield, a seed layer disposed on the first shield, a first free layer disposed on the seed layer, a barrier layer disposed on the first free layer, a second free layer disposed on the barrier layer, a capping layer disposed on the second free layer, and a second shield disposed on the capping layer.

20. A magnetic recording device comprising a DFL read head formed by the method of claim 11.
